(19) United States
(12) Patent Application Publication
(10) Pub. No.: US 2024/0414020 A1
(43) Pub. Date: Dec. 12, 2024

(54) MULTICAST-BROADCAST TRAFFIC DELIVERY FOR DISTRIBUTED TERMINALS

(71) Applicant: INTERDIGITAL PATENT HOLDINGS, INC., Wilmington, DE (US)

(72) Inventors: Magurawalage Chathura Madhusanka Sarathchandra, London (GB); Mona Ghassemian, Kent (GB); Ulises Olvera-Hernandez, Saint-Lazare (CA)

(73) Assignee: INTERDIGITAL PATENT HOLDINGS, INC., Wilmington, DE (US)

(21) Appl. No.: 18/699,474

(22) PCT Filed: Oct. 7, 2022
(86) PCT No.: PCT/US2022/046067

§ 371 Date: Apr. 8, 2024

Related U.S. Application Data
(60) Provisional application No. 63/253,873, filed on Oct. 8, 2021.

(51) Int. Cl. H04L 12/18

(52) U.S. Cl. CPC H04L 12/189; H04L 12/1886

(57) ABSTRACT

In some cases, various advanced end-user devices, such as wireless transmit receive units (WTRUs), may be used for consuming content (e.g., watching/listening to pre-recorded content, interacting with content or others, watching/listening to live content, data, traffic, etc.). Accordingly, in order to satisfy these new use cases, there may be a single PDU session management procedure(s) that distributes a single PDU session among multiple devices over networks. In some cases, there may be the distribution of functions belonging to a single terminal over multiple terminals thereby improving efficiency of execution and improved user experience.

### CROSS-REFERENCE TO RELATED APPLICATIONS

This application claims the benefit of U.S. Provisional Application No. 63/253,873, filed Oct. 8, 2021, the contents of which are incorporated herein by reference.

### SUMMARY

In some cases, various advanced end-user devices, such as wireless transmit receive units (WTRUs), may be used for consuming content (e.g., watching/listening to pre-recorded content, interacting with content or others, watching/listening to live content, data, traffic, etc.). Accordingly, in order to satisfy these new use cases, there may be a single PDU session management procedure(s) that distributes a single PDU session among multiple devices over networks. In some cases, there may be the distribution of functions belonging to a single terminal over multiple terminals thereby improving efficiency of execution and improved user experience.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of an individual and shared delivery methods according to embodiments disclosed herein;

FIG. 3 illustrates an example of an architecture implementing scenarios and embodiments disclosed herein;

FIG. 4 illustrates an example of a scenario in which a single PDU session carries MBS and Non-MBS flows for distributed terminals;

FIG. 5 illustrates an example of actions for MBS and Non-MBS Traffic Transmission over a single PDU session for distributed terminals according to embodiments disclosed herein; and

FIG. 6 illustrates an example of establishing transmission over a single PDU session to embodiments disclosed herein.

### DETAILED DESCRIPTION

In some cases, various advanced end-user devices, such as wireless transmit receive units (WTRUs), may be used for consuming content (e.g., watching/listening to pre-recorded content, interacting with content or others, watching/listening to live content, data, traffic, etc.). Due to the recent advancements in varying device form factors, the ubiquity of those devices with varying capabilities (e.g., video presentation devices such as TVs and projectors, haptic suits, immersive audio systems, etc.) has significantly increased. As a result, multiple modalities (e.g., audio, video, haptic, etc.) of data must be transmitted over the network to those end devices efficiently, while meeting Quality of Experience (QoE) requirements.

However, in legacy scenarios when consuming a single experience, users may be limited to the initial device that is being used for the content/experience, despite other better devices that may become/be available around the user during the interaction with the content/experience (e.g., as the user moves around a house, more devices may come into his/her vicinity). Such legacy scenarios may limit the experience/content to one device (e.g., to a user's mobile phone-unless the user manually configures and/or transfers the experience/content to another device(s).

Therefore, systems, devices, and/or methods are needed for the delivery of content/experiences to more than one WTRU. For example, there is a need for the delivery of multicast-broadcast traffic to distributed WTRUs. Also, there is a need to distribute a single PDU session among multiple WTRUs over networks. There is also a need for distributing functions belonging to a single WTRU over multiple WTRUs (e.g., while distributing a single PDU session). Partitioning of WTRU functions allows for the offloading of specific functionality at the end-device to other devices to be executed for improving the overall experience (e.g., video for a gaming experience may be transferred to a larger display, but functions related to the haptic feedback of the game may be retained at the originating device, thereby providing for a better gaming experience). As a result of this modularization/separation of functions, multimodal flows (e.g., audio, video, input, haptic, etc.) originally sent to only one WTRU, may also be separated and distributed to corresponding WTRU functions that are distributed among multiple WTRUs. Additionally, when utilizing WTRUs that are distributed over a network (e.g., in a 5G system) separate PDU sessions may be used, and as a result, each individual WTRU may be identified not only as a separate independent device, but also as possibly belonging to a separately authorized user. Single PDU session management procedures may allow the utilization of a single PDU session among multiple devices over networks when distributing functions belonging to a single WTRU (e.g., and a single authorized user) over multiple WTRUs. This may improve the efficiency of the content distribution and/or result in an improved user experience. Therefore, functions belonging to a single WTRU may be distributed/offloaded to other WTRUs along with the corresponding PDU session.

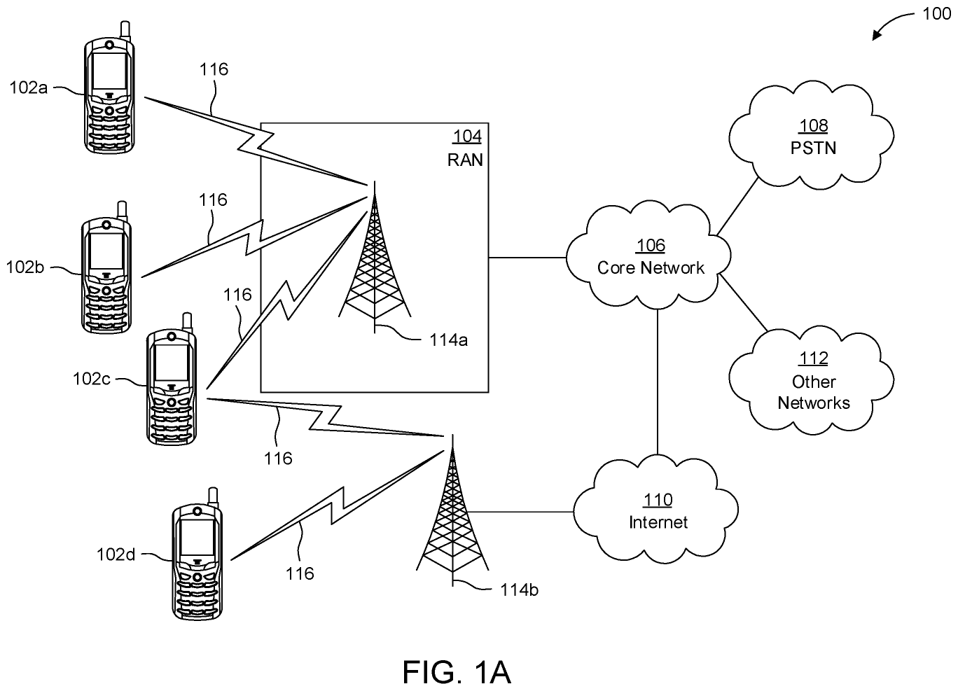

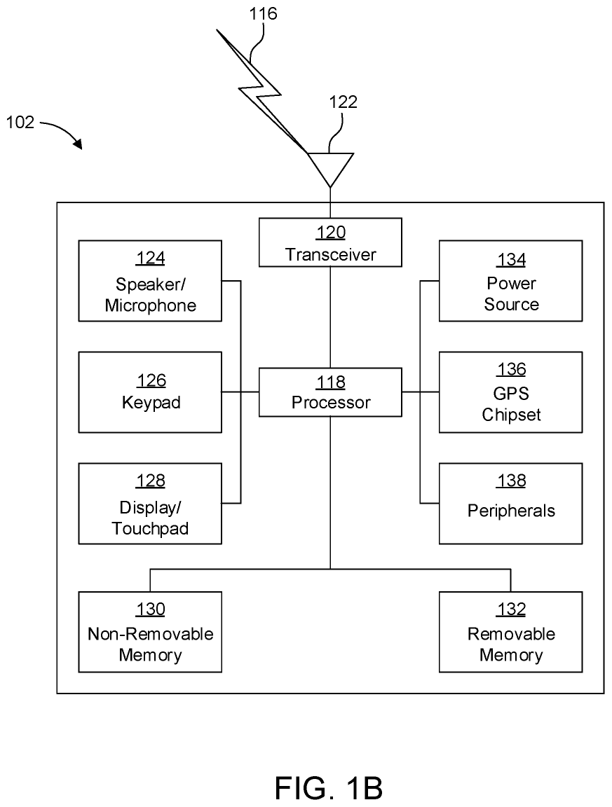

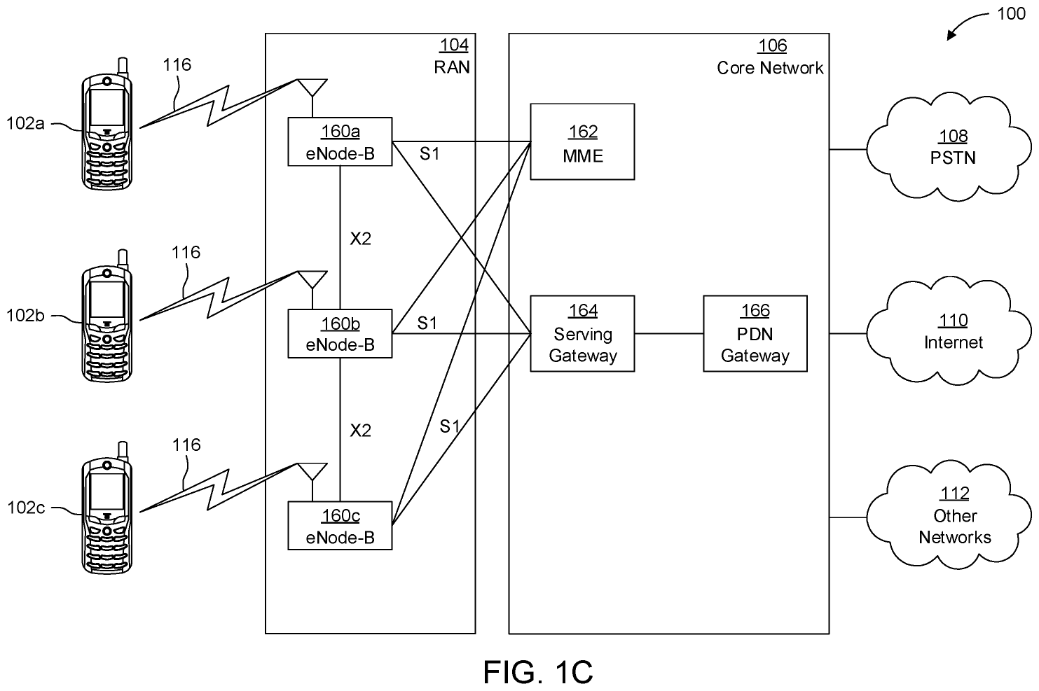

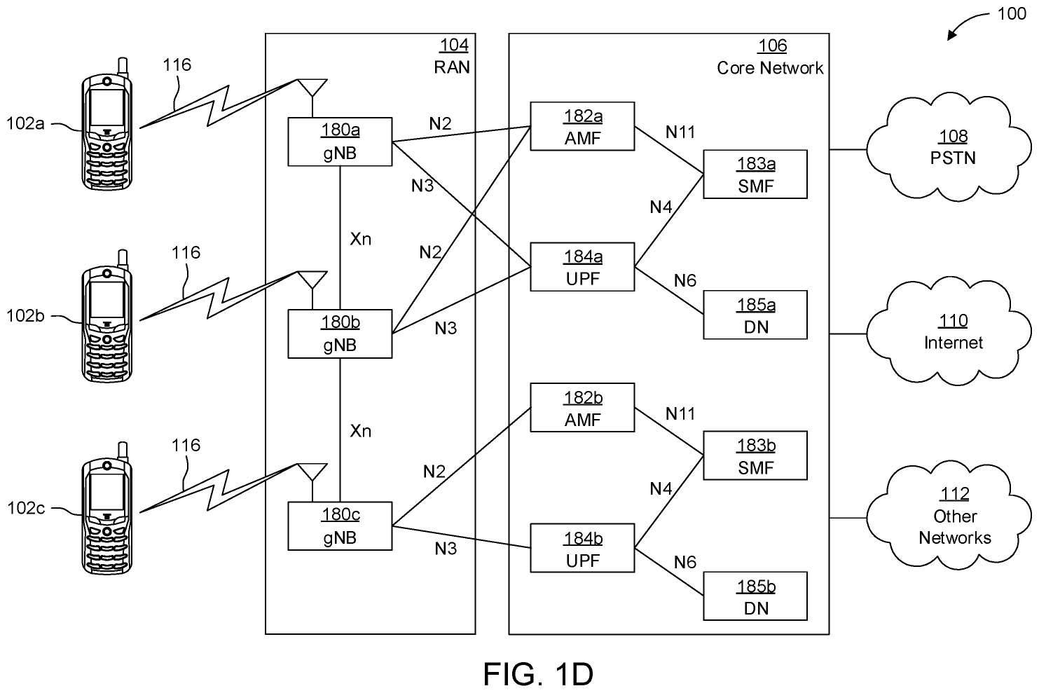

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a terminal, a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d (or any WTRUs described herein) may be interchangeably referred to as one or more of the aforementioned devices.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

Additionally, there may be one or more of the following in an example communication system: Multicast Broadcast User Plane Function (MB-UPF); Application Function (AF); 5G Core (5GC); Access and Mobility management Function (AMF); Session Management Function (SMF); and/or, Multicast Broadcast Session Management Function (MB-SMF). One or more of these components may be embodied virtually (e.g., two entities operating from one device), or physically in a WTRU, or WTRU like hardware device. These are, in some respects, nodes on the network.

Generally, any network side device/node/function/base station, in FIGS. 1A-1D, and/or described anywhere herein, may be interchangeable, and reference to the network may refer to a specific entity on the network side (e.g., in a communication between a WTRU and a network entity, such as a base station), as disclosed herein, such as a device, node, function, base station, cloud, or the like. Further, transmission and reception point (TRP) may be interchangeably used with one or more of TP (transmission point), RP (reception point), RRH (radio remote head), DA (distributed antenna), BS (base station), a sector (of a BS), and a cell (e.g., a geographical cell area served by a BS), but still consistent with this invention. Hereafter, Multi-TRP may be interchangeably used with one or more of MTRP, M-TRP, and multiple TRPs, but still consistent with this disclosure.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

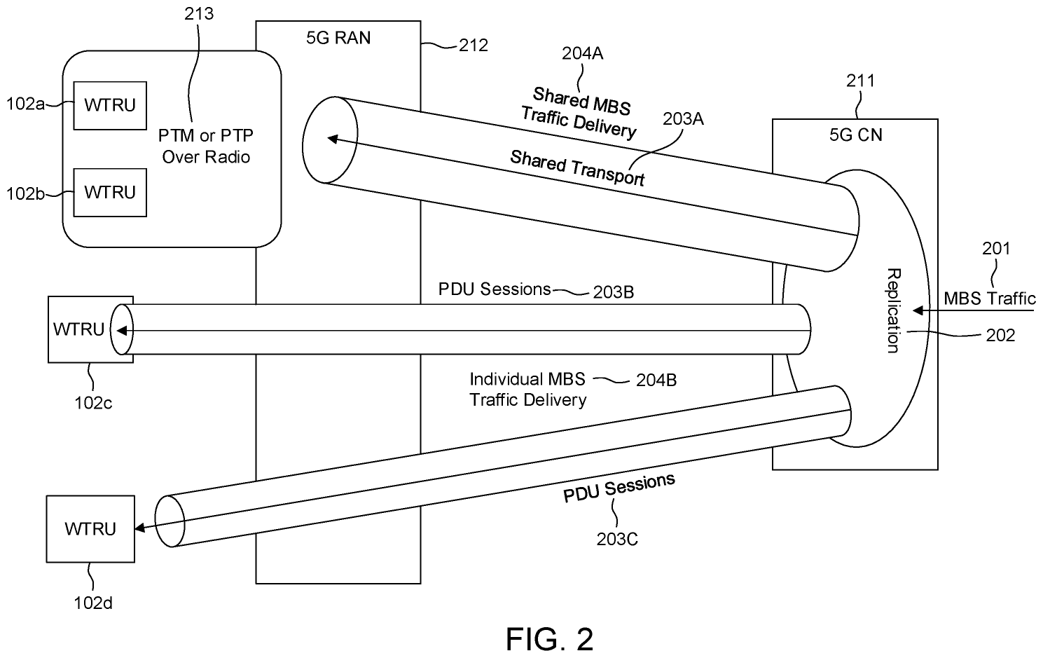

FIG. 2 illustrates an example communication system utilizing multicast broadcast services. Multicast-Broadcast services (MBS) traffic may be used to distribute traffic to multiple WTRUs. In some scenarios, MBS traffic may be used for delivering content from a single data source to multiple WTRUs efficiently. For example, MBS traffic 201 may come from a single source, pass through a core network 211 (e.g., 5G CN) where it is replicated to multiple PDU sessions (e.g., 203B and 203C), where each PDU session may be destined for a different WTRU (e.g., 102C and 102D, respectively). This scenario provides for individual MBS traffic delivery 204B where separate copies of received data packets are delivered to individual WTRUs via PDU sessions.

Multicast may be used for serving several types of data flows (e.g., data modes) to a single user over distributed WTRUs, and for serving multi-modal traffic to multiple users. Depending on various conditions, multiple delivery methods may be used in a communication system. As shown, there may be individual MBS traffic delivery 204B and shared MBS traffic delivery 204A. In the latter, a single copy of MBS packets may be received in a RAN node, which in-turn delivers them to corresponding WTRUs using either Point-to-Point (PTP) or Point-to-Multipoint (PTM) protocols (e.g., 213). For example, MBS traffic 201 may come from a single source, pass through a core network 211 (e.g., 5G CN) where it is sent in a shared transport 203A to radio access network 212, and then is distributed to multiple WTRUs 102a and 102b.

In some cases, MBS traffic may be distributed among the functions that are distributed onto multiple WTRUs. WTRU function distribution involves partitioning of functions running on a WTRU and distributed execution of those functions cooperatively among other participating WTRUs. The partitioned functions may contain different execution requirements and/or different communication requirements/patterns, and/or varying modalities of communication. During this distribution process, the WTRU functions and the single PDU session established for the original WTRU may be distributed among the participating WTRUs. Moreover, multimodal communication may benefit from using multicast/broadcast delivery methods for the distributed WTRU functions depending on their requirements (e.g., two out of five distributed WTRU functions may receive data through multicast, where both functions require the same data). Or the functions may be added to existing multicast groups, freeing the networking from having to separately handle and deliver the same data to the distributed functions, improving the efficiency of communication. In some legacy cases, separate PDU sessions are created for individual delivery and separate shared delivery sessions are created for shared delivery methods, creating additional signaling and resource utilization.

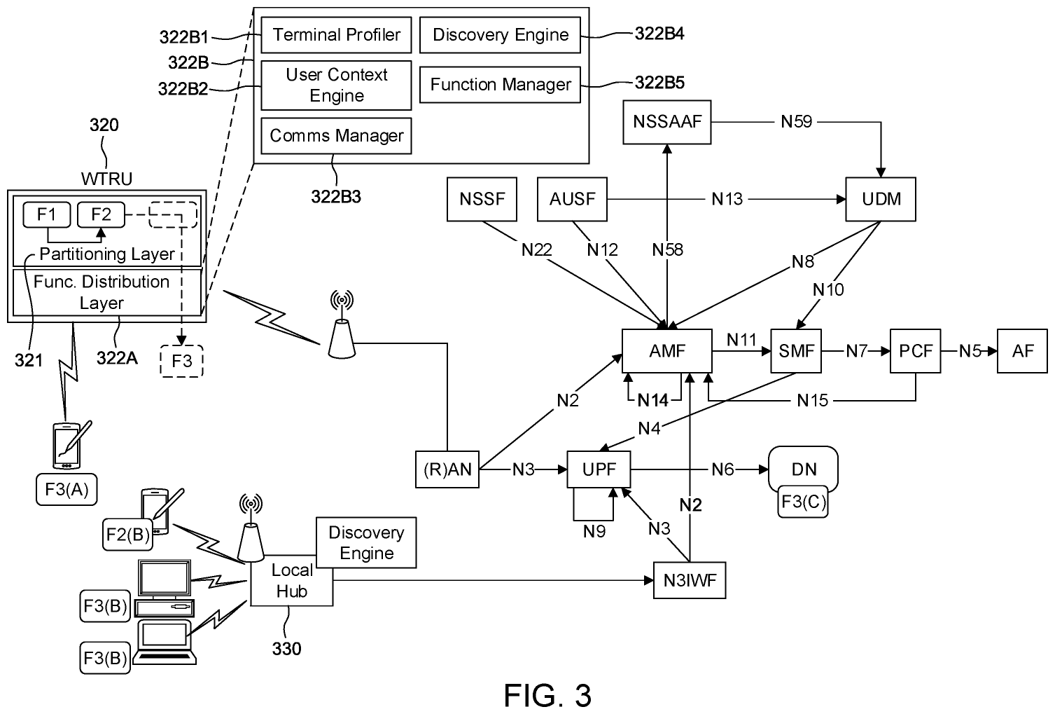

FIG. 3 illustrates an example of different architectures for WTRU function distribution. For illustration purposes, there may be three different scenarios for WTRU function distribution: Device-to-Device (Scenario A), Device-to-Edge (Scenario B), and/or Device-to-Cloud (Scenario C). While examples disclosed herein may discuss on procedures regarding Scenario B and Scenario C, it is understood that the techniques and approaches may apply equally to all scenarios. In any scenario, there may be procedures to distribute WTRU functions and a single PDU session containing MBS flows across multiple WTRUs.

First described herein are the components being used. Then, procedures are described for distributing WTRU functions across multiple WTRUs over a single session.

In the WTRU 320 of FIG. 3, there are at least two layer illustrated: a partitioning layer 321 and a function distribution layer 322A. The function distribution layer 322A may be broken down into components shown at 322B, such as a terminal profiler 322B1, a user context engine 322B2, a discovery engine 322B4, and/or a function manager 322B5. Each component/layer/device illustrated may be optional depending on a given scenario, and the illustration is not intended to be an exhaustive list of component/layer/device for a given scenario.

A function distribution layer (e.g., 322A) is comprised of virtualization of WTRU functions, management of resources (e.g., device local and network), and/or function lifecycle. Functions at various layers of the WTRU stack may be partitioned towards ultimately executing those functions across the network for optimizing resources and user experience.

A profiler (e.g., 322B1) provides functional (e.g., type of hardware functions, system calls, etc.) and runtime information (e.g., runtime CPU, energy utilization, etc.) about existing individual device (e.g. WTRU) functions. Such information may be used for making function lifecycle management and resource management decisions, by both a function manager component (e.g., 322B5) and a comms manager component (e.g., 322B3). This component (e.g., the profiler entity) may be realized as an Operating System or application layer service with security privileges to gather said information.

A user context engine (e.g., 322B2) may gather a user's (e.g., a WTRU's) contextual information through the sensors in the WTRU (e.g., user location through the GPS receiver) and/or through other services/applications providing information indicative of user behavior (e.g., user calendar). This component may be realized as an Operating System or application layer service with API calls to corresponding sensor software drivers and/or webservices (e.g., REST API calls). In some instances, the continuous gathering and storing of such information may lead to excessive usage of persistent and/or non-persistent storage. Therefore, the user context engine (e.g., 322B2) may gather and store information only upon receiving requests from function and comms manager components.

For offloading WTRU functions, the distribution layer must discover available WTRUs that are previously unknown. Especially, in cases where the WTRU (e.g., user) is mobile, suitable WTRUs must be discovered for offloading. The discovery engine (e.g., 322B4) provides an API for actively registering/querying available WTRUs (e.g., for function/comms manager components). Otherwise, it may also actively scout for WTRUs around the WTRU, by periodically scanning the networks, then providing newly found WTRUs to the communication manager components. Such information in turn may be used for making function offloading/distribution decisions. Optionally, the discovery engine may use discovery services provided by the network operator, discovery services provided by non-3GPP access networks, and/or point-to-point WTRUs/network (e.g., Bluetooth) discovery methods for discovering new WTRUs.

The function manager (e.g., 322B5) makes lifecycle management decisions on locally running WTRU functions (e.g., turning off functions of a WTRU to save energy) as well as decisions on offloading/distributing functions to be executed on discovered WTRUs that are better suited. Moreover, taking into account the type of content being used by each individual participating WTRU, the function manager may also decide whether each individual function must receive data using either unicast or multicast (MBS). Ultimately, the decisions being made may optimize the energy efficiency of the local WTRU, resource utilization of the WTRU and the network, and/or the overall user experience. Such decisions may be made using information gathered on user behavior (e.g., through a context engine), resource consumption (e.g., through a profiler), and user mobility/WTRU availability (e.g., discovery engine).

A communication manager (e.g., 322B3) manages the interconnectivity between WTRUs that provide capabilities for the distributed execution of WTRU functions, as well as the interconnectivity between the functions themselves. Such a procedure may include selection (e.g., network selection) and/or management of communication medium functions. The communication manager may also initiate connectivity with the 5GC and manage corresponding QoS and MBS flows (e.g., establishment of MBS flows as described herein).

Regarding a local hub (e.g., 330), end-user devices, such as a WTRU, may provide resources to be used by other WTRUs/users in their vicinity (e.g., computing resources, display screens, etc.) via a local hub. The local hub provides an API (e.g., functionality of the discovery engine) for such resource provider WTRUs, for registering their capabilities, to be discovered by other WTRUs within the user vicinity (e.g., home, campus, shopping mall). Access to the local hub and its APIs (e.g., registry and discovery) may be provided over a wireless network (e.g., Wi-Fi, or the like). Capability and available information of each registering WTRU may be provided to the local hub during registration and, stored in the local hub until they are deregistered or a specific registration expiry time lapses. The local hub may operate as an independent entity without any direct connectivity to an operator's core network, or it may connect to the operator's network as a non-3GPP (e.g., Wi-Fi) network for extending various operator's network services to the connected WTRUs.

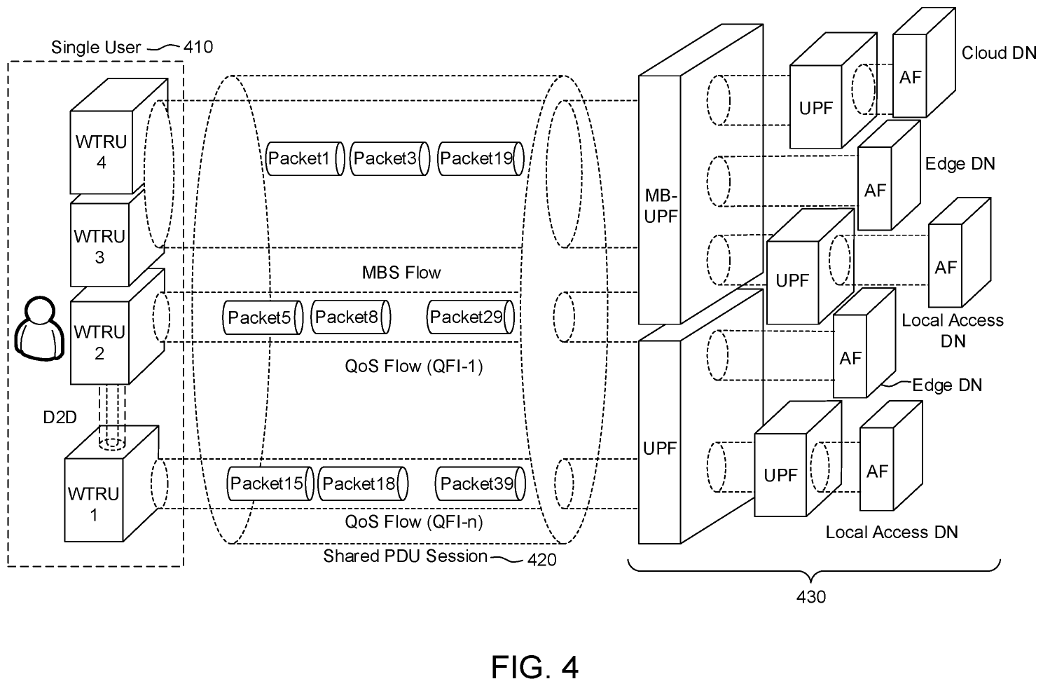

FIG. 4 illustrates an example scenario of delivering traffic (e.g., packets) to distributed WTRUs of a single user. Specifically, there may be the delivery of MBS and Non-MBS flows (e.g., data, packets, content, etc.) originating from one or more sources (e.g., 430) over a single PDU session (e.g., shared PDU session 420) for distributed WTRUs (e.g., single user 410, including WTRU1, WTRU2, WTRU3, and/or WTRU4). The WTRUs may be connected to various sources 430, such as specialized application functions (AFs). The AFs may reside in one or more delivery networks (DNs), such as local access DN, edge DN, and/or cloud DN. In one instance, the WTRUs 410 may be connected to other (not shown) WTRUs (e.g., exclusively or in addition to the delivery networks) through a network, for executing distributed functions. The WTRUs used for executing functions that require the same MBS traffic (e.g., two displays that display the same videos—WTRU 3 and WTRU 4 as shown) may receive the same MBS flows, while other data (e.g., haptic data that are specific to the specific user and only required to be received by one WTRU-WTRU 1 and/or WTRU 2) may be delivered through unicast.

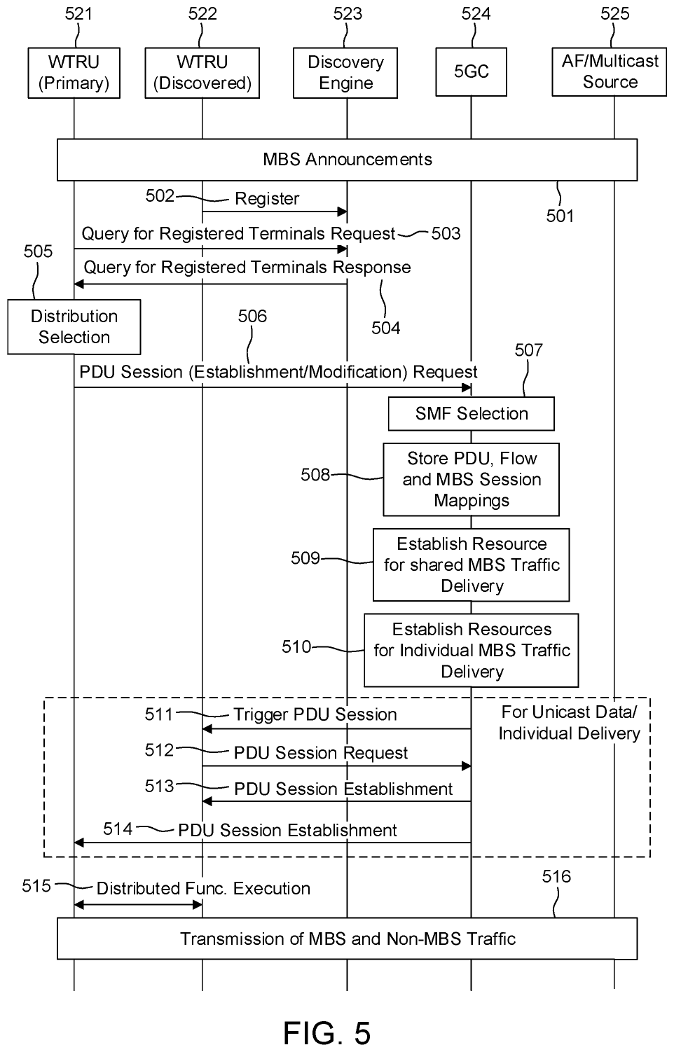

FIG. 5 illustrates an example method for transferring MBS traffic and non-MBS traffic over the same PDU session for distributed WTRUs. For context, for example, WTRU 2, WTRU 3 and WTRU 4 (as illustrated in FIG. 4) may be sub-WTRUs that receive the same modality flow, WTRU 1 may receive a unicast flow, and these WTRUs may go through one or more aspects of the procedure of FIG. 5. As discussed herein, reference to either receiving or sending a unicast flow or a multicast flow may be accomplished in sending an indication there of, or some other means for exchanging this information (e.g., within or part of another message).

As shown in FIG. 5, in this example scenario there may be a primary WTRU 521 that may initiate the procedures for function distribution to other chosen WTRUs (e.g., discovered WTRU 522) over a single PDU session. It may be assumed, for the sake of demonstration, that MBS sessions have been configured in the 5GC, but alternative scenarios may exist and still be consistent with the techniques described herein. In this scenario, there may also be a discovery engine 523 (e.g., located on a single WTRU, multiple WTRUs, remote from or part of one of the WTRUs, etc.), a 5GC, and an AF/Multicast source 525 of content/traffic/etc.

All WTRUs belonging to the user may receive at least the MBS session ID information of multicast groups of interest, which they can join, such as via service announcement (e.g. MBS Announcements 501). The WTRUs that are available for onloading functions that are being distributed, may register (e.g., 502) with the discovery engine 523 (e.g., in local hub). The registration process may gather/collect and store a WTRU ID for each WTRU that uniquely identifies that WTRU within the 5G Core (5GC) network 524. Along with the WTRU ID, each registering WTRU may provide device information, such as its computing (e.g., CPU size, RAM size), networking (e.g., Cellular status) capabilities and/or location information (i.e., GPS coordinates) to the discovery engine 523.

WTRUs may register through an API that is provided by the discovery engine 523. The registration may be automatically performed by discovering WTRUs within the proximity. The WTRU ID may also be a service ID, or any other sharable ID which can be used to uniquely identify WTRUs, or services/functions within them.

The primary/initiating WTRU 521 may send a request for querying (e.g., 503) newly discovered/updated WTRUs 522 from the discovery engine 523. In case the discovery engine 523 resides within the same device, a callback or IPC (Inter-processor communication) procedure may be used for obtaining this information. The primary WTRU 521 may have any required access permissions in the discovery engine 523 (e.g., in the local hub) for obtaining this information. Alternatively, the primary WTRU 521 may receive updates on newly discovered WTRUs automatically.

The discovery engine 523 may respond back (e.g., 504) to the primary WTRU 521 with all information gathered, such as of each registered WTRU. The primary WTRU 521 may decide on the most suitable distribution (e.g., 505) of WTRU functions among the WTRUs (e.g., performing the role of the function manager). When making the function distribution decision (e.g., 505), it uses information gathered from the profiler, user context engine, discovery engine, and/or any other function for deciding one or more factors, such as what (e.g., which functions), when (e.g., the appropriate time), and/or where (e.g., best WTRUs), to offload a function. Alternatively, the selection of the most suitable distribution of WTRU functions may be performed by an entity within the network (e.g., an application function at the edge, a dedicated node within the network, etc.).

Once a distribution selection has been made, and one or more WTRUs for distributing/offloading have been selected (e.g., according to one or more factors), the primary WTRU 521 (e.g., communication manager) may trigger the function distribution process by establishing connectivity for the selected WTRUs. This may include initiating the creation/modification of a PDU session (e.g., 506), to be shared among all participating WTRUs, by communicating with the 5G core network.

As part of the session initiation, the primary WTRU 521 may generate a session ID. The IDs of the WTRUs that are being selected, along with the session ID, may be provided to the 5GC for creating a single session to be distributed among the selected WTRUs. This message may also contain information about multicast sessions each individual may be WTRU required to join (e.g., added as a vector/list/key-value pair). This may include one or more MBS session IDs, or any other identifiers to identify MBS traffic, that indicates the multicast groups that a WTRU wants to join, including the join request.

This process may deviate/modify legacy MBS session establishment procedures. For example, this process may incorporate additional WTRU and flow information (e.g., such as the information described herein). In cases where the decision on the distribution of WTRU functions is performed by an entity in the network, this request may be performed by the corresponding entity (e.g., following network-triggered PDU session initiation). A vector indicating if each individual WTRU supports the single PDU session may be added to this message. In cases where WTRU(s) do not support single PDU session creation, conventional PDU sessions may be used for those subsets of WTRUs. In such a case, the 5GC 524 (e.g., SMF) may maintain a list of all PDU IDs used and associated with the WTRU/user such that the deciding entity has access or has been given this information at some point in the process.

The 5GC 524 may authorize the establishment of connectivity for the selected WTRUs (e.g., for the same user). A session management function (SMF), or the AMF at the initial stage of selecting a SMF, may identify, discover, and/or select an MB-SMF for the corresponding MBS sessions, per each individual WTRU, in a provided list. If one or more WTRUs require receiving MBS traffic, the SMF may authorize the MBS sessions for the WTRUs belonging to the same user. If no appropriate MB-SMF is configured, the SMF may perform the configuration or reject the request. The MB-SMF may select and/or configure a MB-UPF corresponding to each individual WTRU accordingly.

The 5GC 524 (e.g., AMF/SMF) may perform the selection of corresponding SMFs (e.g., 507) for unicast flows and MB-SMF for multicast flows, per each individual WTRUs, according to MBS session information provided (e.g., as previously described in this example process). For keeping track of the mapping between the PDU session, unicast, and/or multicast flows (e.g., MBS sessions and contexts) belonging to the same user, the 5GC 524 may store (e.g., 508) the mapping information (e.g., in the SMF, AMF and/or RAN).

If it has been decided to use a shared delivery method for one or more WTRUs, and if resources for shared MBS traffic delivery have not been already established, the 5GC may establish the required resources (e.g., shared tunnel) (e.g., 509). This may be executed separately for each MBS session. If it has been decided to use unicast/individual delivery method for one or more WTRUs, and if resources for unicast/individual MBS traffic delivery have not been already established, then the 5GC may establish the required resources for unicast/individual delivery (e.g., 510). This may be executed separately for each MBS session.

For WTRUs using unicast flows, the 5GC 524 may send a PDU session trigger message(s) (e.g., 511) to all WTRUs (e.g., WTRU IDs). The 5GC 524 may use trigger procedures (e.g., such as SMS, or the like) for performing this step. Alternatively, a SMF may send the trigger message to all corresponding WTRUs.

All WTRUs (e.g., 522) that receive the PDU session trigger request, may send a PDU session establishment request (e.g., 512) to the 5GC 524. The 5GC 524 may establish PDU sessions (e.g., 513) with the provided WTRUs (e.g., WTRU IDs), using the same session ID. Therefore, the corresponding WTRUs may be added to the same PDU session. All selected/discovered WTRUs may be added to the same PDU session. The 5GC 524 may accept and establish (e.g., 514) the PDU session with the primary/initiating WTRU 521.

Execution of the distribution functions may be initiated/continued (e.g., 515) by establishing communication among the corresponding functions. (e.g., between the primary WTRU 521 and one or more discovered WTRUs 522). This may include the transferring of the function code as well as other data being used by the function (e.g., synchronization of data/states).

MBS traffic is transferred from the source (AF), through the 5G network, to the corresponding WTRUs (e.g., 516). The 5GC may handle the traffic as per the configurations described herein, and may use the chosen delivery methods per each individual WTRU, accordingly. For the WTRUs that have chosen a conventional unicast delivery, the corresponding PDU/unicast flows may be used for delivering the content.

In some cases, for unicast there may be a 1-1 mapping between the MBS session and a GTP-U tunnel towards a RAN node, and for multicast transport there may be a 1-1 mapping between the MBS session and the GTP-U tunnel. As described herein, where a single PDU session incorporates both unicast and multicast flows, the flows within the PDU session may be delivered through both unicast and multicast GTP-U tunnels simultaneously.

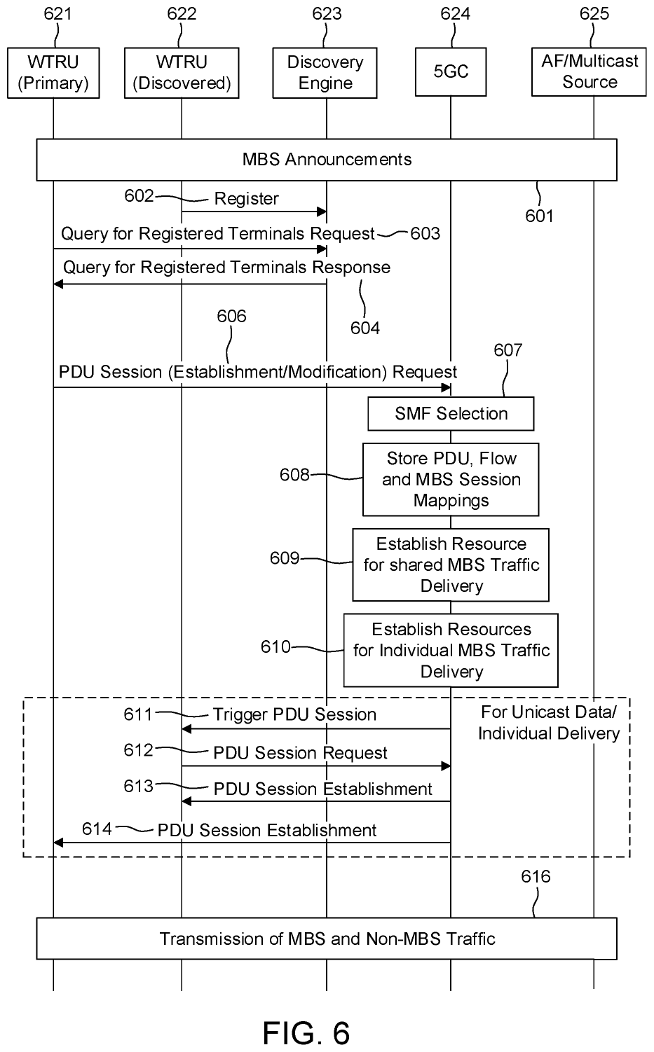

FIG. 6 illustrates an example method for transferring MBS traffic and non-MBS traffic over the same PDU session for distributed WTRUs. For context, for example, WTRU 2, WTRU 3 and WTRU 4 (as illustrated in FIG. 4) may be sub-WTRUs that receive the same modality flow, WTRU 1 may receive a unicast flow, and these WTRUs may go through one or more aspects of the procedure of FIG. 5.

In this example scenario there may be a primary WTRU 621 that may initiate the procedures for function distribution to other chosen WTRUs (e.g., discovered WTRU 622) over a single PDU session. It may be assumed, for the sake of demonstration, that MBS sessions have been configured in the 5GC, but alternative scenarios may exist and still be consistent with the techniques described herein. In this scenario, there may also be a discovery engine 623 (e.g., located on a single WTRU, multiple WTRUs, remote from or part of one of the WTRUs, etc.), a 5GC, and an AF/Multicast source 625 of content/traffic/etc.

All WTRUs belonging to the user may receive at least the MBS session ID information of multicast groups of interest, which they can join, such as via service announcement (e.g. MBS Announcements 601). The WTRUs that are available for being part of the same PDU session may register/be discovered (e.g., 602) with the discovery engine 623 (e.g., in local hub, in primary WTRU, etc.). The registration process may gather/collect and store a WTRU ID for each WTRU that uniquely identifies that WTRU within the 5G Core (5GC) network 624. Along with the WTRU ID, each registering WTRU may provide device information, such as its computing (e.g., CPU size, RAM size), networking (e.g., Cellular status) capabilities and/or location information (i.e., GPS coordinates) to the discovery engine 623.

WTRUs may register through an API that is provided by the discovery engine 623. The registration may be automatically performed by discovering WTRUs within the proximity. The WTRU ID may also be a service ID, or any other sharable ID which can be used to uniquely identify WTRUs, or services/functions within them.

The primary/initiating WTRU 621 may send a request for querying (e.g., 603) newly discovered/updated WTRUs 622 from the discovery engine 623. In case the discovery engine 623 resides within the same device, a callback or IPC (Inter-processor communication) procedure may be used for obtaining this information. The primary WTRU 621 may have any required access permissions in the discovery engine 623 (e.g., in the local hub) for obtaining this information. Alternatively, the primary WTRU 621 may receive updates on newly discovered WTRUs automatically.

The discovery engine 623 may respond back (e.g., 604) to the primary WTRU 621 with all information gathered, such as of each registered WTRU. The primary WTRU 621 may decide on the a configuration for a single PDU session (e.g., 605) for all involved WTRUs. This decision may use information gathered from the profiler, user context engine, discovery engine, and/or any other function for deciding one or more factors, such as the what (e.g., traffic/content), when (e.g., the appropriate time), and/or where (e.g., best WTRUs), for the purposes of a single PDU session with multiple WTRUs. Alternatively, this decision may be performed by an entity within the network (e.g., an application function at the edge, a dedicated node within the network, etc.).

Once a decision has been made, and one or more WTRUs have been selected (e.g., according to one or more factors), the primary WTRU 621 (e.g., communication manager) may trigger a process by establishing connectivity for the selected WTRUs. This may include initiating the creation/modification of a PDU session (e.g., 606), to be shared among all participating WTRUs, by communicating with the 5G core network.

As part of the session initiation, the primary WTRU 621 may generate, or receive from the application/service provider, a session ID. The IDs of the WTRUs that are being selected, along with the session ID, may be provided to the 5GC for creating a single session to be distributed among the selected WTRUs. This message may also contain information about multicast sessions each individual may be WTRU required to join (e.g., added as a vector/list/key-value pair). This may include one or more MBS session IDs, or any other identifiers to identify MBS traffic, that indicates the multicast groups that a WTRU wants to join, including the join request.

This process may deviate/modify legacy MBS session establishment procedures. For example, this process may incorporate additional WTRU and flow information (e.g., such as the information described herein). In cases where the decision on the distribution of WTRU functions is performed by an entity in the network, this request may be performed by the corresponding entity (e.g., following network-triggered PDU session initiation). A vector indicating if each individual WTRU supports the single PDU session may be added to this message. In cases where WTRU(s) do not support single PDU session creation, conventional PDU sessions may be used for those subsets of WTRUs. In such a case, the 5GC 624 (e.g., SMF) may maintain a list of all PDU IDs used and associated with the WTRU/user such that the deciding entity has access or has been given this information at some point in the process.

The 5GC 624 may authorize the establishment of connectivity for the selected WTRUs (e.g., for the same user). A session management function (SMF), or the AMF at the initial stage of selecting a SMF, may identify, discover, and/or select an MB-SMF for the corresponding MBS sessions, per each individual WTRU, in a provided list. If one or more WTRUs require receiving MBS traffic, the SMF may authorize the MBS sessions for the WTRUs belonging to the same user. If no appropriate MB-SMF is configured, the SMF may perform the configuration or reject the request. The MB-SMF may select and/or configure a MB-UPF corresponding to each individual WTRU accordingly.

The 5GC 624 (e.g., AMF/SMF) may perform the selection of corresponding SMFs (e.g., 607) for unicast flows and MB-SMF for multicast flows, per each individual WTRUs, according to MBS session information provided (e.g., as previously described in this example process). For keeping track of the mapping between the PDU session, unicast, and/or multicast flows (e.g., MBS sessions and contexts) belonging to the same user, the 5GC 624 may store (e.g., 608) the mapping information (e.g., in the SMF, AMF and/or RAN).

If it has been decided to use a shared delivery method for one or more WTRUs, and if resources for shared MBS traffic delivery have not been already established, the 5GC may establish the required resources (e.g., shared tunnel) (e.g., 609). This may be executed separately for each MBS session. If it has been decided to use unicast/individual delivery method for one or more WTRUs, and if resources for unicast/individual MBS traffic delivery have not been already established, then the 5GC may establish the required resources for unicast/individual delivery (e.g., 610). This may be executed separately for each MBS session.

For WTRUs using unicast flows, the 5GC 624 may send a PDU session trigger message(s) (e.g., 611) to all WTRUs (e.g., WTRU IDs). The 5GC 624 may use trigger procedures (e.g., such as SMS, or the like) for performing this step. Alternatively, a SMF may send the trigger message to all corresponding WTRUs.

All WTRUs (e.g., 622) that receive the PDU session trigger request, may send a PDU session establishment request (e.g., 612) to the 5GC 624. The 5GC 624 may establish PDU sessions (e.g., 613) with the provided WTRUs (e.g., WTRU IDs), using the same session ID. Therefore, the corresponding WTRUs may be added to the same PDU session. All selected/discovered WTRUs may be added to the same PDU session. The 5GC 624 may accept and establish (e.g., 614) the PDU session with the primary/initiating WTRU 621.

Execution of the selection of discovered WTRUs may be initiated/continued (e.g., 615) by establishing communication among the other WTRUs with the discovering entity. (e.g., between the primary WTRU 621 and one or more discovered WTRUs 622). This may include the transferring of information, establishing connections (e.g., direct or indirect), tunneling, synchronization of data/states, etc.

MBS traffic is transferred from the source (AF), through the 5G network, to the corresponding WTRUs (e.g., 616). The 5GC may handle the traffic as per the configurations described herein, and may use the chosen delivery methods per each individual WTRU, accordingly. For the WTRUs that have chosen a conventional unicast delivery, the corresponding PDU/unicast flows may be used for delivering the content.

In some cases, for unicast there may be a 1-1 mapping between the MBS session and a GTP-U tunnel towards a RAN node, and for multicast transport there may be a 1-1 mapping between the MBS session and the GTP-U tunnel. As described herein, where a single PDU session incorporates both unicast and multicast flows, the flows within the PDU session may be delivered through both unicast and multicast GTP-U tunnels simultaneously.

In another example, there may be a method implemented by a primary wireless transmit receive unit (WTRU) for using one PDU session with multiple WTRUs. The primary WTRU may send a PDU session establishment request to establish a single, shared PDU session for the primary WTRU and one or more other WTRUs. The PDU establishment request may include at least one multicast flow and at least one unicast flow for the single, shared PDU session. The primary WTRU may receive a PDU session establishment response establishing the single, shared PDU session with the one or more other WTRUs. The primary WTRU may receive information about the one or more other WTRUs from a discovery function. The discovery function may be a part of the network or a part of the primary WTRU. The primary WTRU may receive information for a plurality of WTRUs, and may select the one or more other WTRUs from the plurality of WTRUs based on the information. The primary WTRU may receive data from one or more delivery networks, wherein the delivery network is an edge, a cloud, or a local access source of data. The one or more other WTRUs and the primary WTRU may have a common PDU session ID. In some instances, a multi-broadcast announcement precedes the PDU session establishment request. All WTRUs may share a common element, such as an ID, a user, a session ID, or some other identifier. A component of the network, as described herein, may receive the request, process/implement the request, and respond to one or more of the WTRUs that are involved, as well as communication with the delivery network.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method implemented by a primary wireless transmit receive unit (WTRU), the method comprising:
sending a PDU session establishment request to establish a single, shared PDU session for the primary WTRU and one or more other WTRUs, wherein the PDU establishment request includes at least one indication of a multicast flow and at least one indication of a unicast flow, wherein the indicated multicast flow and the indicated unicast flow are associated with the single, shared PDU session; and
receiving a PDU session establishment response establishing the single, shared PDU session with the one or more other WTRUs.

2. The method of claim 1, further comprising receiving an indication of the one or more other WTRUs from a discovery function.

3. The method of claim 1, further comprising receiving information for a plurality of WTRUs, and selecting the one or more other WTRUs from the plurality of WTRUs based on the information.

4. The method of claim 1, further comprising receiving data from one or more delivery networks, wherein the delivery network is an edge system, a cloud system, or a local access system source of data.

5. The method of claim 1, wherein the one or more other WTRUs and the primary WTRU have a common PDU session ID.

6. The method of claim 1, wherein a multi-broadcast announcement precedes the PDU session establishment request.

7. A primary wireless transmit receive unit (WTRU), the primary WTRU comprising:
processor operatively coupled to a transceiver, the processor and transceiver configured to send a PDU session establishment request to establish a single, shared PDU session for the primary WTRU and one or more other WTRUs, wherein the PDU establishment request includes at least one indication of a multicast flow and at least one indication of a unicast flow, wherein the indicated multicast flow and the indicated unicast flow are associated with the single, shared PDU session; and
the processor and transceiver configured to receive a PDU session establishment response establishing the single, shared PDU session with the one or more other WTRUs.

8. The primary WTRU of claim 7, wherein the processor and transceiver are further configured to receive an indication of the one or more other WTRUs from a discovery function.

9. The primary WTRU of claim 7, wherein the processor and transceiver are further configured to receive information for a plurality of WTRUs, and selecting the one or more other WTRUs from the plurality of WTRUs based on the information.

10. The primary WTRU of claim 7, wherein the processor and transceiver are further configured to receive from one or more delivery networks, wherein the delivery network is an edge system, a cloud system, or a local access system source of data.

11. The primary WTRU of claim 7, wherein the one or more other WTRUs and the primary WTRU have a common PDU session ID.

12. The primary WTRU of claim 7, wherein a multi-broadcast announcement precedes the PDU session establishment request.
